(19) United States
(12) Patent Application Publication
(10) Pub. No.: US 2024/0102506 A1
(43) Pub. Date: Mar. 28, 2024

(54) LOCKING WASHER AND METHOD FOR PRODUCING SAME, AND SCREW CONNECTION USING SUCH A LOCKING WASHER

(71) Applicant: ADOLF SCHNORR GMBH & CO. KG, STUTTTGART (DE)

(72) Inventors: CHRISTOF SEYBOLDT, STUTTGART (DE); HUMBERTO DO LAGO E PRETTI, SINDELFINGEN (DE)

(21) Appl. No.: 18/261,546

(22) PCT Filed: Jan. 17, 2022
(86) PCT No.: PCT/EP2022/050892

§ 371 Date: Jul. 14, 2023

(30) Foreign Application Priority Data
Jan. 18, 2021 (DE) 10 2021 100 880.8

(51) Int. Cl. F16B 39/24; B21D 53/24

(52) U.S. Cl. CPC F16B 39/24; B21D 53/24

(57) ABSTRACT

The invention relates to a locking washer for a screw connection (31) and to a method for producing same, as well as to a screw connection (31) between at least one component (32) and a screw partner (33), which can be interconnected via a screw part (21), the locking washer comprising an annular washer body (12) which is delimited by a peripheral outer rim (17) and an inner rim (18), comprising a receiving bore (19) which is delimited by the inner rim (18) and into which the screw part (21) can be inserted, comprising an upper annular face (16) and lower annular face (14) provided on the annular washer body (12), and comprising a toothing (23) which is provided on the lower annular face (14) and the upper annular face (16) and which extends across the width of the particular annular face (14, 16) and over the entire periphery, wherein the annular washer body (12) is placed at an angle (α) of equal to or greater than 20° in relation to a plane (25) formed by a peripheral front edge (20) of the peripheral outer rim (17).

### CROSS REFERENCE TO RELATED APPLICATIONS

This application is a US national phase application of PCT/EP2022/050892

### STATEMENT REGARDING FEDERALLY SPONSORED RESEARCH OR DEVELOPMENT

Not applicable.

### BACKGROUND OF THE INVENTION

### Technical Field

The invention relates to a lock washer for a screw connection between a screw part and a component, and a method for producing such a lock washer. The invention further relates to a screw connection in which a lock washer is provided between a screw part and a component.

### Related Background Art

Lock washers, in particular toothed lock washers, are known from DE 44 25 837 A1. Such a lock washer comprises an annular washer body delimited by an outer edge and an inner edge running concentrically thereto. In the washer body, a receiving hole for receiving a screw part is provided that is delimited by the inner edge. This washer body comprises an upper and lower ring surface that consistently has a toothing on the upper and lower ring surface respectively. In other words, this lock washer is set up to be curved in the manner of a disc spring. An outer peripheral edge of the lock washer abuts, in the untensioned state, on a component, and an inner peripheral edge abuts on a screw head to form a screw connection. The requirements of such screw connections are increasing, and also require protection for a screw connection when countersunk screws are used.

The object of the invention is to propose a lock washer and a method for the production thereof, as well as a screw connection, such that a sufficient form and force fit is enabled between the lock washer and a component and between a screw part having a countersunk head and the component with the interposition of the lock washer.

### BRIEF SUMMARY OF THE INVENTION

This object is solved by a lock washer for a screw connection, wherein an annular screw body is positioned at an angle α greater than or equal to 20° in relation to a plane formed by a peripheral end edge of the peripheral outer edge of the washer body. Due to such a design of the lock washer, in which an upper ring surface has an angle α greater than or equal to 20° in relation to a peripheral outer edge, a screw part having a countersunk head, in particular countersunk screws, can also be force- and form-fittingly secured in a sink of a hole in the component. Due to this positioning of the lock washer, the lock washer can abut both on a conical outer periphery of the countersunk head and on the sink in the hole after the countersunk screw is fixed, in order to enable this securing.

According to a preferred embodiment of the lock washer, the annular washer body is positioned at an angle α between 20° and 45°, preferably between 25° and 45°, in particular between 30° and 45° in relation to a plane formed by the peripheral end edge of the peripheral outer edge of the lock washer. This represents a preferred range for a plurality of uses.

According to an alternative embodiment of the lock washer, this angle α for positioning the annular washer body lies in a range of greater than 25°, preferably greater than 30°, in particular greater than 45°. A form fit can thus already be built at the beginning when tightening or tensioning the screw part with a further screw or tension partner.

Such lock washers according to one of the embodiments described above preferably consist of a spring steel, a tempered spring steel, stainless steel, a non-ferrous metal alloy or a plastic.

The object of the invention is further solved by a method for producing a lock washer, wherein a pilot hole is punched in a flat strip or a flat band-like material, wherein a bowl is shaped or deep-drawn with a embossing stamp and a counter embossing stamp, the tilted peripheral surface of said bowl being wider than the annular washer body of the produced lock washer, and wherein a toothing is introduced into the tilted peripheral surface of the upper and lower ring surface, wherein the peripheral surface is tilted at an angle α greater than or equal to 20° in relation to a plane of the sheet of material by the embossing stamp, wherein the pilot hole introduced into the band material and arranged on the base of the bowl provided in the bowl is punched onto a gauge block with at least one further punching stamp, and wherein an outer edge of the bowl is punched onto a gauge block with a third punching stamp and the produced lock washer is guided out of the band material. By introducing a pilot hole before introducing the bowl with a peripheral surface positioned at an angle greater than or equal to 20° in relation to the plane of the band-like material, a flow of the material on the inner edge of the bowl is enabled when the stamp is introduced, such that crack formation can be avoided. Due to this series of steps for producing the lock washer, positioned lock washers can be produced, in which the annular lock washer is positioned at an angle α greater than or equal to 20° in relation to a peripheral outer edge.

According to a preferred embodiment, a punching stamp can be used to carry out the method, the angle α of which, starting from the plane of the band-like material, is designed to be between 20° and 45°, preferably between 25° and 45°, in particular between 30° and 45°, or alternatively greater than 25°, preferably greater than 30°, in particular greater than 45°.

The object of the invention is further solved by a screw connection of at least one component and one screw partner that are connected to the screw part, and the screw part is designed with a countersunk head and with a lock washer positioned between the screw part and the component, wherein the lock washer is designed according to one of the embodiments described above. Due to such a lock washer having an annular washer body positioned at an angle α greater than or equal to 20° in relation to the plane formed by the peripheral outer edge, the lock washer abuts flush in a sink in the component when a countersunk head is screwed, and the countersunk head is preferably connected flush to the surface of the component. The lock washer can enable a form-fit lock via its toothing and the positioned geometry and enable a force-fit lock via its shape and/or its spring effect.

The countersunk head of the screw part preferably has a conical outer periphery that preferably comprises a cone of 90°.

The component is further designed having a conical sink starting from a surface of the component to a through hole in the component, wherein the spacing between the surface of the component and the beginning of the through hole has an total depth t that is formed from a “t₁ value” and a “δt₁ value”. The value “δt₁” corresponds to the sheet thickness of the lock washer cos (45°). The “t₁ value” corresponds to the value for sinks according to DIN EN ISO 15065 or DIN 74. Using this measurement of the sink, after the screw part is completely tightened, an end face of the screw part abuts flush on the surface of the component with the countersunk head.

It is further preferably provided that, in a first connecting phase after the introduction of the lock washer and of the screw part into the through hole in the component, an upper end edge of the outer edge of the upper ring surface abuts on the sink, and an inner edge of the outer ring surface is elevated in relation to the sink. An introduction of force is thus enabled on the outer edge of the upper ring surface in a first connecting phase. A linear introduction of force is thus in particular given.

According to an alternative embodiment, it is provided that, in a first connecting phase after the introduction of the lock washer and of the screw part into the through hole in the component, an end edge of the outer periphery, which borders the inner ring surface, abuts on the conical outer periphery of the countersunk head of the screw part, and an inner edge of the inner ring surface is elevated in relation to the conical outer periphery. In the case of such a starting position, an annular introduction of force is given between the lock washer and the sink in the component when the screw is tightened.

It is further preferably provided that, after the screw part is tightened, the lock washer abuts completely with its lower ring surface on the countersunk head and with its upper ring surface completely on the sink in the component, and an end surface of the countersunk head or screw part is preferably flush with the surface of the component.

The invention and further advantageous embodiments and developments of the same are described and explained in more detail in the following using examples represented in the drawings. The features to be understood from the description and the drawings can be used individually or in any of several combinations according to the invention.

### BRIEF DESCRIPTION OF THE DRAWINGS

FIG. 1 shows a schematic view of an underside of a lock washer.

FIG. 2 shows a schematic side view of the lock washer according to FIG. 1.

FIG. 3 shows a schematic side view from above of the lock washer according to FIG. 1.

FIG. 4 shows a schematic sectional view of the lock washer according to FIG. 1.

FIG. 5 shows a schematic side view of a first step for producing the lock washer according to FIG. 1.

FIG. 6 shows a schematic side view of a further step.

FIG. 7 shows a schematic side view of a further following step.

FIG. 8 shows a schematic side view of a last step for producing the lock washer according to FIG. 1.

FIG. 9 shows a schematic sectional view of a screw connection in a first connecting phase.

FIG. 10 shows a schematic sectional view of a screw connection according to an alternative embodiment to FIG. 9 in a first connecting phase.

FIG. 11 shows a schematic side view of a tightened screw connection.

### DETAILED DESCRIPTION OF THE INVENTION

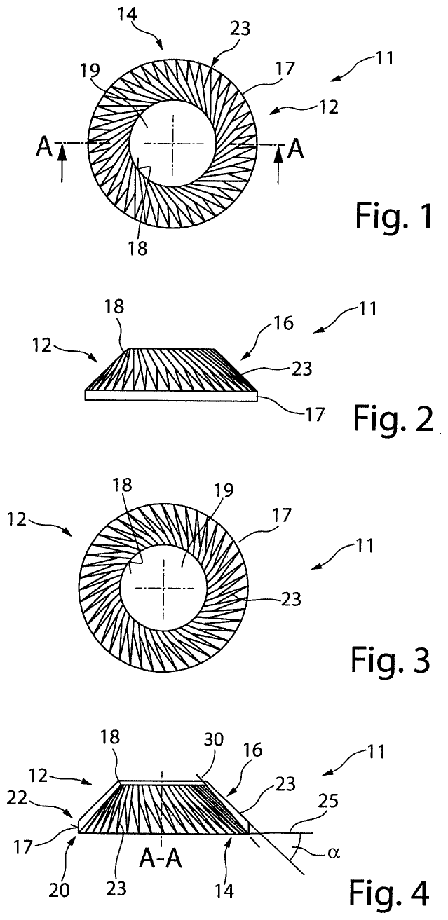

In FIG. 1, a schematic view from below of a lock washer 11 is depicted. FIG. 2 shows a schematic side view of the lock washer 11. In FIG. 3, a schematic view from above is depicted, and FIG. 4 shows a schematic sectional view along the line A-A in FIG. 1.

This lock washer 11 comprises a washer body 12 that is designed to be disc-shaped or annular. This disc-shaped or annular washer body 12 is positioned. This washer body 12 comprises a lower ring surface 14 which is depicted in FIG. 1 and an upper ring surface 16 which is depicted in FIG. 2. The upper and lower ring surface 14, 16 are respectively delimited by a peripheral outer edge 17 and a preferably concentric inner edge 18. The inner edge 18 delimits a receiving hole 19 that is provided for insertion of a screw part 21 (FIG. 11). A toothing 23 is provided on the lower ring surface 14 and on the upper ring surface 16, which extends entirely. The toothing 23 further extends over the entire width of the lower and upper ring surface 14, 16, specifically from the inner edge 18 to the outer edge 17.

Alternatively, a flat region can be provided on the outer edge 17, such that the teeth bordering the outer edge 17 are flattened in this region. The toothing 23 on the underside and the top side is preferably designed as a helical toothing. Such a toothing 23 can be produced by shaping.

The lock washer 11 according to FIGS. 1 to 4 preferably has a positioned washer body 12. This arises from the sectional view according to FIG. 4. The washer body 12 is designed in the manner of a disc spring. An inner edge 18 of the washer body 12 is designed to be elevated in relation to an outer edge 17. This lock washer 11 can thus generate a pre-tensioning force acting on a screw connection.

In the case of this lock washer 11, the annular washer body 12 is aligned or positioned at an angle greater than or equal to 20° in relation to a peripheral end edge 20 on the outer edge 17. This washer body 12 corresponds to a shell of a frustum. This end edge 20 on the outer edge 17 lies in a plane 25. The annular washer body 12 is tilted or positioned at an angle greater than or equal to 20° in relation to this plane 25. A bowl-shaped recess is given when observing from an underside of the lock washer 11. When viewed from the side, the lock washer 11 has a frustum-shaped contour, wherein the tilt of the cone-shaped peripheral surface or the upper ring surface 16 of the washer body 12 encloses an angle of 20° or more in relation to the plane 25 formed by the peripheral end edge 20.

In this embodiment of the lock washer 11, the peripheral outer edge 17 can further be designed at a right angle to the plane 25. The peripheral outer edge 17 is formed by a peripheral end edge 20 lying in the plane 25 and delimited by a further or second end edge 22 arranged spaced apart therefrom. In this preferred embodiment, the first and the second end edge 20, 22 lie in a plane perpendicular to the plane 25.

This lock washer 11 can be formed from a steel, from a spring steel, from a corrosion-resistant steel, from a light metal alloy or from a plastic.

To produce this lock washer 11 having an annular washer body 12 positioned at an angle α greater than or equal to 20° in relation to a peripheral end edge 20 of the outer edge 17, production is preferably carried out according to the steps described in the following.

The lower and upper ring surface 14, 16 are aligned running in parallel with one another or running conically to the inner edge 18. When viewed in cross-section, the washer body 12 has a longitudinal axis 30 and the lower and upper ring surface 14, 16 are aligned in parallel with or conically to said axis. The longitudinal axis 30 is designed as a straight line. The washer body 12 is designed unbent or free of bends along its longitudinal axis 30.

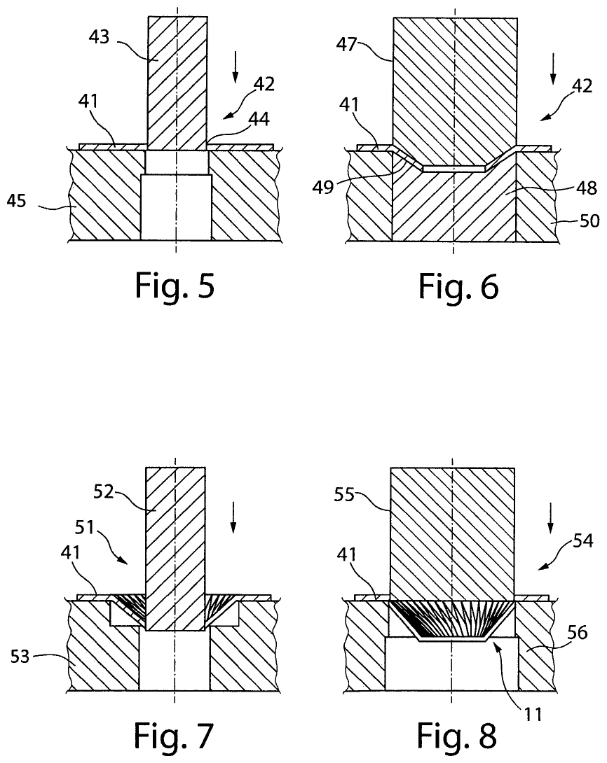

A first step is depicted in FIG. 5. A band-like material 41 is provided as a strip, for example. This band-like material 41 is fed to a first punching tool 42. A pilot hole 44 is formed by a hole stamp 43 of the first punching tool 42, the periphery of said pilot hole being equal to or smaller than the periphery of the inner edge 18 of the produced lock washer 11.

The pre-punched band-like material is then fed to a first shaping tool 46 for a subsequent step according to FIG. 6. This shaping tool 46 has a embossing stamp 47 and a counterstamp 48 designed to be bowl-shaped. In this shaping step, the edge region extending around the pilot hole 44 is re-shaped as a bowl 49. The toothing 23 is simultaneously introduced onto the top side and the underside of the band-like material 31.

In a following step according to FIG. 7, the band-like material 41 with the introduced bowls 49 is fed to a second punching tool 51. With this punching tool 51, the pilot hole 44 is punched onto a gauge block with a punching stamp 52 and the inner edge 18 is formed. A flat region can simultaneously be formed in this punching process bordering the inner edge 18 and pointing towards the upper ring surface 16.

In a last punching step according to FIG. 8, the lock washer 11 is produced to completion with a third punching tool 54. The outer edge 17 is cut by a punching stamp 55, and the lock washer 24 is ejected downwards by a punching die 56.

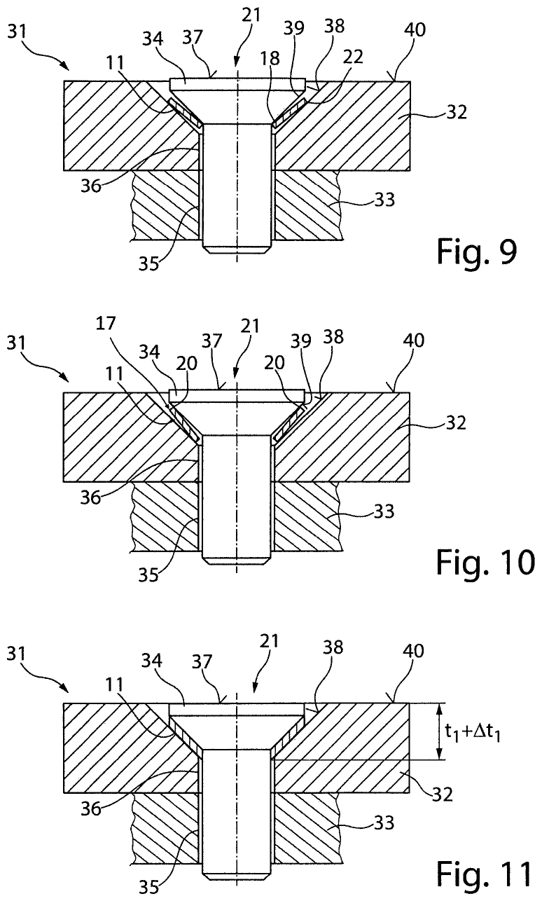

In FIG. 9, a schematic sectional view of a screw connection 31 to be formed is depicted in a first connecting phase. In this embodiment according to FIG. 9, the lock washer 11 is positioned at an angle between 20° and 45°. The screw connection 31 is formed by a component 32 and a screw partner 33 that is to be connected to said component, wherein the screw part 21 is fixed to the component 32 with the interposition of the lock washer 11. In a first connecting phase, the lock washer 11 is positioned with the screw part 21 positioned towards the through hole 36 of the component 32 and inserted, such that a thread 35 of the screw part 21 can then engage with the screw partner 33. In a first connecting phase, a second end edge 22 of the outer edge 17 of the annular washer body 12 abuts on a sink 38 in the component 32. An inner edge 18 of the annular washer body 12 is elevated in relation to the sink 38. This inner edge 18 can abut on a peripheral surface 39 of the countersunk head 34. In a following fixing phase, for example when tightening the screw part 21, the washer body 12 is pressed. The peripheral surface 39 of the countersunk head 34 presses the inner edge 18 of the washer body 12 onto the sink 38 of the component 32. A clawing of the lower or inner ring surface 14 with the peripheral surface 39 of the countersunk head 34 and/or a clawing of the upper or outer ring surface 16 with the sink 38 of the component 32 is thus enabled.

In FIG. 10, an alternative embodiment to FIG. 9 is depicted. In this embodiment according to FIG. 10, the lock washer 11 is positioned at an angle α greater than or equal to 45°. Reversed relationships are thus given in relation to the embodiment in FIG. 9. The lock washer 11 abuts on the peripheral surface 39 of the countersunk head 34 with a peripheral end edge 20 of the outer edge 17. An outer end edge of the inner edge 18 of the lock washer 11 can abut on the sink 38. In the fixing phase, the washer body 12 is pushed onto the outer edge 17.

The depth of the sink 38 in the component 32 is designed in this screw connection 31 in such a way that, for example, the “t₁” value known from DIN EN ISO 15065 is increased by the value “Δt₁”. The value “Δt₁” results from the thickness of the annular washer body/cos (45°). After the screw part 21 having the countersunk head 34 is tightened, an end face 37 of the countersunk head 34 abuts flush on the surface 40 of the component 32. FIG. 11 shows this arrangement. The lock washer 11 simultaneously engages flush with the lower ring surface 14 on the peripheral surface 39 of the countersunk head 34, and the upper ring surface 16 engages flush on the sink 38 of the component 32.

We claim:

1. A lock washer for a screw connection between at least one component and a screw partner which can be connected to each other by a screw part, the lock washer comprising:
a. an annular washer body delimited by a peripheral outer edge and an inner edge, and,
b. a receiving hole delimited by the inner edge, into which the screw part can be introduced, and,
c. an upper ring surface and a lower ring surface provided on the annular washer body, and,
d. a toothing provided on the lower ring surface and on the upper ring surface, the toothing extending over the width of the lower ring surface and the upper ring surface and over the entire periphery of the lower ring surface and the upper ring surface,
e. wherein, the annular washer body is positioned at an angle (α) greater than or equal to 20° in relation to a plane formed by a peripheral end edge of the peripheral outer edge.

2. The lock washer according to claim 1, wherein the annular washer body is positioned at an angle (α) between 20° and 45°, or between 25° and 45°, or between 30° and 45° in relation to the plane formed by the peripheral end edge of the peripheral outer edge.

3. The lock washer according to claim 1, wherein the annular washer body is positioned at an angle (α) greater than 25°, or greater than 30°, or greater than 45° in relation to the plane formed by the peripheral end edge of the peripheral outer edge.

4. The lock washer according to claim 1, wherein the annular washer body is produced from a spring steel, from a stainless steel, from a non-ferrous metal material or from plastic.

5. A method for producing a lock washer for a screw connection, the lock washer having an annular washer body that is delimited by a peripheral outer edge and an inner edge, wherein the inner edge delimits a receiving hole, and having a toothing provided on an upper ring surface and a lower ring surface, and the toothing extending over an entire periphery of the upper ring surface and the lower ring surface, the method comprising:
a. a pilot hole is punched into a flat, band-like material, having a plane, with a first punching tool, and,
b. a bowl having a top side and a underside, is shaped with an embossing stamp and a counterstamp, a tilted peripheral surface of said bowl being wider than the annular washer body of the lock washer, and the toothing is introduced into the tilted peripheral surface on the top side and the underside, and,
c. the tilted peripheral surface is tilted at an angle (α) greater than or equal to 20° in relation to a plane of the band-like material by the embossing stamp, and,
d. the pilot hole is punched onto a gauge block with a first punching stamp of a second punching tool, and,
e. an outer edge of the annular washer body is punched onto a gauge block with a third punching tool by a second punching stamp, and the lock washer is guided out of the third punching tool by a punching die.

6. The method according to claim 5, wherein, the embossing stamp and the counterstamp are shaped such that the peripheral surface of the bowl is tilted at an angle (α) between 20° and 45°, or between 25° and 45°, or between 30° and 45° in relation to the plane of the band-like material.

7. The method according to claim 5, wherein the embossing stamp and the counterstamp are shaped such that the peripheral surface of the bowl is tilted at an angle (α) greater than 25°, or greater than 30°, or greater than 45° in relation to the plane of the band-like material.

8. A screw connection comprising:
a. at least one component and one screw partner, which are connected to each other by a screw part equipped with a countersunk head, and,
b. a lock washer positioned between the at least one component and the screw part,
c. wherein the lock washer comprises:
i. an annular washer body that is delimited by a peripheral outer edge and an inner edge, wherein the inner edge delimits a receiving hole, and,
ii. a toothing provided on an upper ring surface and a lower ring surface, the toothing extending over an entire periphery of the upper ring surface and the lower ring surface, and,
iii. the annular washer body is positioned at an angle (α) greater than or equal to 20° in relation to a plane formed by a peripheral end edge of the peripheral outer edge.

9. The screw connection according to claim 8, wherein the countersunk head of the screw part has a conical outer periphery, and the conical outer periphery of the countersunk head preferably comprises a conical shape with an angle of 90°.

10. The Screw connection according to claim 8, wherein the component has a conical sink starting from a surface of the component up to a through hole, and the sink is introduced at a depth t that is formed from a “t₁” value for sinks according to DIN EN ISO 15065 and a further value “Δt₁”, wherein the “Δt₁” is the value of the thickness of the annular washer body of the lock washer divided by cos (45°).

11. The screw connection according to claim 8, wherein, in a first connecting phase after the introduction of the lock washer and the screw part into the through hole of the component, a second end edge of the outer edge of the lock washer abuts on the sink of the component, and an inner edge of the upper ring surface is elevated in relation to the sink.

12. The screw connection according to claim 8, wherein, in a first connecting phase after the introduction of the lock washer and the screw part into the through hole of the component, a peripheral end edge on the outer edge of the lock washer, which borders the inner ring surface, abuts on the peripheral surface of the countersunk head of the screw part, and an inner edge of the lock washer is elevated in relation to the outer peripheral surface of the countersunk head of the screw part.

13. The screw connection according to claim 8, characterised in that, after the screw part is completely tightened, the lock washer abuts flush with its lower ring surface flush on the outer peripheral surface of the countersunk head and abuts with its lower surface flush on the sink on the component to connect the component to the screw partner.
